(19) United States
(12) Patent Application Publication
(10) Pub. No.: US 2010/0286945 A1
(43) Pub. Date: Nov. 11, 2010

(54) METHOD OF ESTIMATING TEMPERATURE DISTRIBUTION HISTORY

(76) Inventors: Yoshihiko Tango, Yokohama-shi (JP); Morinobu Ishiyama, Tokyo (JP); Naoki Osawa, Osaka (JP); Kiyoshi Hashimoto, Osaka (JP); Junji Sawamura, Osaka (JP)

Correspondence Address: OSTROLENK FABER GERB & SOFFEN, 1180 AVENUE OF THE AMERICAS, NEW YORK, NY, 100368403, US

(21) Appl. No.: 12/743,901

(22) PCT Filed: Nov. 21, 2008
(86) PCT No.: PCT/JP2008/071237

§ 371 Date: May 20, 2010

(30) Foreign Application Priority Data
Nov. 21, 2007 (JP) P2007-302082

(51) Int. Cl. G01K 3/00; G06F 15/00

(52) U.S. Cl. 702/130; 374/137

(57) ABSTRACT

A method is provided for estimating a temperature distribution history in the case of line-heating flat-plate steel by high frequency induction. The method of estimating the temperature distribution history includes a first step of measuring a history of temperature distribution that is generated when a test piece of sheet steel is spot-heated; a second step of analyzing an induction current distribution that is generated when the sheet steel is spot-heated; a third step of expressing the induction current distribution by an approximation equation of the initial induction current distribution at an initial temperature and temperature dependent correction factor of the initial induction current distribution, and identifying the initial induction current distribution and the temperature dependent correction factors based on the temperature distribution history and the induction current distribution; a fourth step of analyzing internal heat generation from the initial induction current distribution, the temperature dependent correction factor, and a temperature dependency of electrical resistivity of the sheet steel; and a fifth step of analyzing the temperature distribution history generated during the line heating by applying the internal heat generation to the sheet steel while the internal heat generation is being moved. According to the method, the temperature distribution history in the case where the flat-plate steel is line-heated by high frequency induction can be efficiently estimated at high precision.

### TECHNICAL FIELD

The present invention relates to a method of estimating a temperature distribution during high frequency induction line-heating processing of flat-plate steel.

The present application contains subject matter related to that disclosed in Japanese Priority Patent Application JP 2007-302082 filed on Nov. 21, 2007 in the Japanese Patent Office, the content of which is hereby incorporated by reference.

### BACKGROUND ART

In the related art, large-scale three-dimensional curved surfaces, such as ship hull plate or the like, have been mostly formed by line heating. Although forming by line heating has been performed by skilled workers using their experience and intuition, the lack of productive capacities is growing with the aging of such workers.

Accordingly, research has been progressing in order to seek automation of the forming of three-dimensional curved surfaces, and in regard to the forming of small curvature surfaces, automation of forming by line heating has already been successful. In this method, straight-line heating tests for each heating condition (e.g. specification of a coil, excitation frequency, current, voltage, moving speed of a coil, or the like) are performed, inherent strains are classified and put into a database, and heating lines are arranged based on the analysis using the database. In forming small curvature surfaces, the heating lines are largely-spaced, and thus respective heating units can follow the above-described method without interfering with one another (See Non Patent Document 1).

However, in forming large-curvature surfaces, the heating lines may be densely-arranged, the same place may be repeatedly-heated, or the heating lines may cross each other. Also, since a non-straight line heating is frequently used, the generated inherent strains differ even if the heating conditions are the same.

Accordingly, even if the inherent strains according to the heating conditions of the respective heating lines are overlapped by using the database, the resultant inherent strains may differ from the actually generated inherent strains. Accordingly, if the heating lines are arranged based on the inherent strains identified by the straight-line heating test, the working accuracy deteriorates beyond the permissible limit.

That is, the inherent strains that are generated during large-curvature surface forming process (e.g. under the conditions such as narrow gaps between the heating lines, the repeated heating of the heating lines, crossing of the heating lines, non-straight heating lines, or the like) are different from the inherent strains from the straight-line heating test, and have not yet been identified. Accordingly, the automation of the forming of the large-curvature surfaces has not been achieved.

[Non Patent Document 1] Ishiyama et al., “Automatic line-heating bending process method applying a finite element method (FEM)”, Manual of Ishikawa-jima Harima 1999 Vol. 39 No. 2 p. 60-p. 64

### DISCLOSURE OF THE INVENTION

### Technical Problem

In order to realize automation of forming of large curvature surfaces, thermo-elasto-plasticity analysis is necessary in which heat input from a heating source to a steel plate by line heating has been evaluated with high precision.

The line heating is usually performed using gas heating. However, high-frequency induction heating, or the like, for the purpose of automation, it is preferable to perform heating by electromagnetic induction using a high-frequency induction heating device from the viewpoint of control and management. For heat-transfer analysis of induction heating in the case where a high-frequency coil is stationary, coupling analysis for an electromagnetic field and heat conduction performed by using commercial non-linear finite element codes, such as ANSYS, ABAQUS and MARC, have been used as methods in the related art.

It is necessary to arrange ultra-fine mesh in the heat generation layer with a thickness equal to or less than 0.1 mm in the coupling analysis for the electromagnetic field and the heat conduction of the high-frequency induction line heating. This ultra fine mesh has to be arranged along the moving trace of the coil, and it is also needed to mesh the air layer up to an infinite distance. Such analysis model is so complicated that it requires impractical number of man-hours. Due to this, the heat transfer analysis during induction line heating process cannot be realized, and thus it is actually not possible to identify the inherent strains in the forming of large-curvature surfaces by using coupling analysis for the electromagnetic field and heat conduction in the related art.

In order to analyze the inherent strains generated in the forming of large-curvature surfaces without following the method in the related art and to remove obstacles to automation, as a pre-stage process, it is necessary to estimate a thermal cycle (i.e. temperature distribution history) by one line heating. If it is possible to estimate the thermal cycle, the identification of the inherent strains can be performed based on the estimated temperature history. However, the estimation of the thermal cycle during line heating has not yet able to be performed.

The invention has been made in consideration of the above-described circumstances, and an object of the invention is to provide a method of efficiently estimating a temperature distribution history (i.e. thermal cycle) at high precision in the case where flat-plate steel is line-heated by high frequency induction.

### Technical Solution

The method of estimating a temperature distribution history according to an embodiment of the present invention adopts the following means to solve the above-described object.

The method of estimating a temperature distribution history according to an embodiment of the present invention includes a first step of measuring a history of temperature distribution that is generated when a test piece of sheet steel is spot-heated by high-frequency induction; a second step of obtaining an induction current distribution that is generated when the sheet steel is spot-heated by the high-frequency induction by using finite element analysis; a third step of expressing the induction current distribution by an approximation equation of the initial induction current distribution at an initial temperature and temperature dependent correction factors of the induction current, and identifying the initial induction current distribution and the temperature dependent correction factors based on the temperature distribution history obtained in the first step and the induction current distribution obtained in the second step; a fourth step of obtaining internal heat generation by using the initial induction current distribution and the temperature dependent correction factor obtained in the third step and a temperature dependency of electrical resistivity of the sheet steel; and a fifth step of obtaining the temperature distribution history generated during the line heating by the finite element analysis by applying the internal heat generation that is obtained in the fourth step to the sheet steel while the internal heat generation moves on with the heating coil.

In the fifth step, the initial induction current distribution identified in the spot heating test may be applied to the sheet steel as the heating coil moves in a straight line or in a curve with respect to a main surface of the sheet steel.

Also, in the fifth step, the initial induction current distribution identified in the spot heating test may be applied to the sheet steel as the internal heat generation moves at constant speed or at varying speed with respect to the sheet steel.

Also, in the first step, the sheet steel may be spot-heated by a high-frequency induction coil.

### Advantageous Effects

As described above, according to the present invention, the following effects can be obtained.

By using the method of estimating the temperature distribution history according to the present invention, the temperature distribution history (i.e. thermal cycle) that is generated when the sheet steel is line-heated can be analyzed (or estimated) with high precision.

Particularly, since only the heat-conduction analysis is performed in the fifth step, i.e. in the step of analyzing the line heating, the temperature distribution history (i.e. thermal cycle) can be analyzed (i.e. estimated) at high precision in a short amount of time without performing cumbersome electromagnetic field analysis. That is, by obtaining the initial induction current distribution and the temperature dependent correction factor in advance, the temperature distribution history (i.e. thermal cycle) during line-heating process can be efficiently obtained at high precision without performing the electromagnetic field analysis even if the moving speed of the high-frequency induction coil is changed or the high-frequency induction coil is not moved in a straight line.

### BRIEF DESCRIPTION OF DRAWINGS

FIG. 1 is a view illustrating a mechanism that generates induction current for induction heating.

FIG. 2 is a diagram illustrating temperature measurement points when flat-plate steel is spot-heated.

FIG. 3 is a diagram illustrating the electromagnetic properties of flat-plate steel.

FIG. 4 is a diagram illustrating the thermal properties of flat-plate steel.

FIG. 5 is a diagram illustrating the actual measurement values and the results of analysis at respective temperature measurement points of flat-plate steel.

FIG. 6 is a diagram illustrating the results of analysis of induction current in flat-plate steel (with a depth of 0.2 mm).

FIG. 7 is a diagram illustrating the results of analysis of induction current in flat-plate steel (with a depth of 0.01 mm).

FIG. 8 is a diagram illustrating the results of identification of the initial induction current distribution.

FIG. 9 is a diagram illustrating the results of identification of the temperature dependent correction factors.

FIG. 10 is a diagram illustrating the internal heat generation obtained using Equation (2).

FIG. 11 is a diagram illustrating the temperature distribution history that is generated when flat-plate steel is line-heated (when the high-frequency induction coil is moving at a speed of 1000 mm/min).

FIG. 12 is a diagram illustrating the temperature distribution history that is generated when flat-plate steel is line-heated (when the high-frequency induction coil is moving at a speed of 300 mm/min).

### EXPLANATION OF REFERENCE

A: flat-plate steel (sheet steel)

C: high-frequency induction coil

10, 20: experiment device

### BEST MODE FOR CARRYING OUT THE INVENTION

Hereinafter, with reference to the accompanying drawings, a method of estimating a temperature distribution history according to embodiments of the present invention will be described.

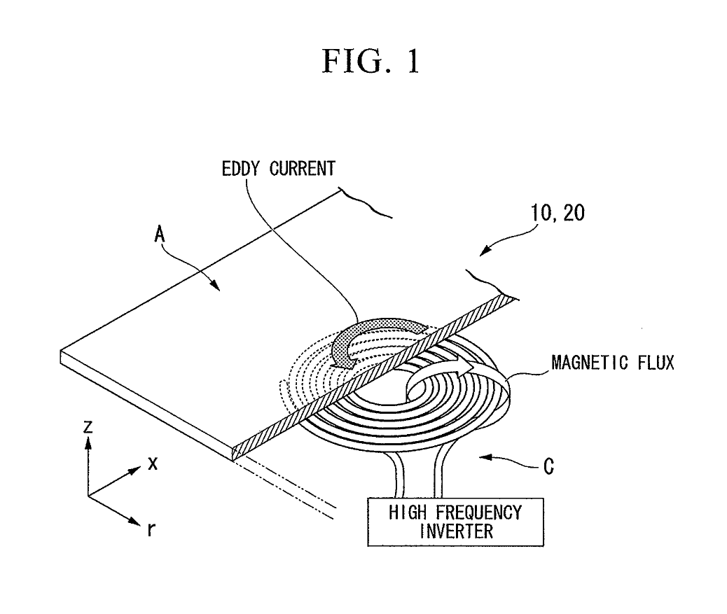

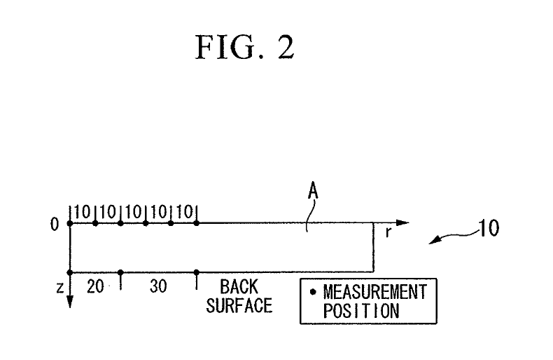

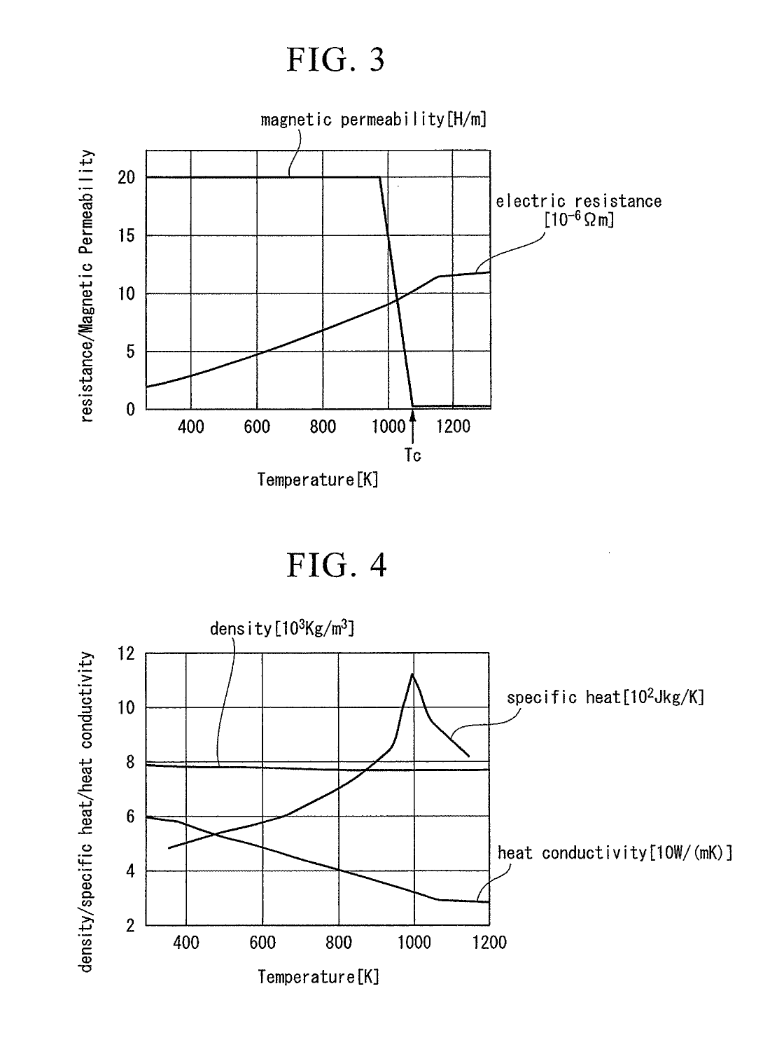

FIG. 1 is a view explaining a method of estimating a temperature distribution history according to an embodiment of the present invention, and shows a mechanism that generates induction current for induction heating. FIG. 2 is a diagram illustrating temperature measurement points when flat-plate steel is spot-heated. FIG. 3 is a diagram illustrating the electromagnetic properties of flat-plate steel, and FIG. 4 is a diagram illustrating the thermal properties of flat-plate steel.

According to the method of estimating a temperature distribution history (i.e. thermal cycle) according to an embodiment of the present invention, the temperature distribution history that is generated in flat-plate steel A when the flat-plate steel A is line-heated by a high-frequency induction coil C is estimated using the results obtained when the flat-plate steel A is spot-heated by the high-frequency induction coil C.

The method of estimating a temperature distribution history according to an embodiment of the present invention includes a first step of measuring a history of temperature distribution that is generated when flat-plate steel A is spot-heated by a high-frequency induction coil C; a second step of obtaining an induction current distribution I(r, z, T) that is generated when the flat-plate steel A is spot-heated by the high-frequency induction coil C by using finite element analysis; a third step of expressing the induction current distribution I(r, z, T) by an approximation equation in terms of positioning and temperature, and identifying the approximation equation based on the temperature distribution history obtained in the first step and the induction current distribution I(r, z, T) obtained in the second step; a fourth step of obtaining internal heat generation by using the initial induction current distribution I₀(r,z) and temperature dependent correction factors w(T) obtained in the third step and the temperature dependency R(T) of the electrical resistivity of the flat-plate steel A; and a fifth step of obtaining the temperature distribution history that is generated during the line heating by the finite element analysis by applying the internal heat generation that is obtained in the fourth step to the flat-plate steel A while the internal heat generation moves on with the heating coil.

As illustrated in FIG. 1, an experiment apparatus that is composed of the flat-plate steel A and the high-frequency induction coil C is prepared. The experiment apparatus includes two kinds of experiment devices: an experiment device 10 that performs the spot-heating of the flat-plate steel A through the high-frequency induction coil C, and an experiment device 20 that performs the line heating of the flat-plate steel A.

In the experiment device 10 that performs the spot-heating of the flat-plate steel A, the high-frequency induction coil C is arranged in the center of the sufficiently-sized flat-plate steel A.

Also, as illustrated in FIG. 2, a plurality of thermocouples is arranged on the flat-plate steel A to measure the temperature-time history during the induction heating.

Also, as the first step of the method of estimating the temperature distribution history, the temperature distribution history (i.e. the thermal cycle) is measured when the flat-plate steel A is spot-heated by the high-frequency induction coil C.

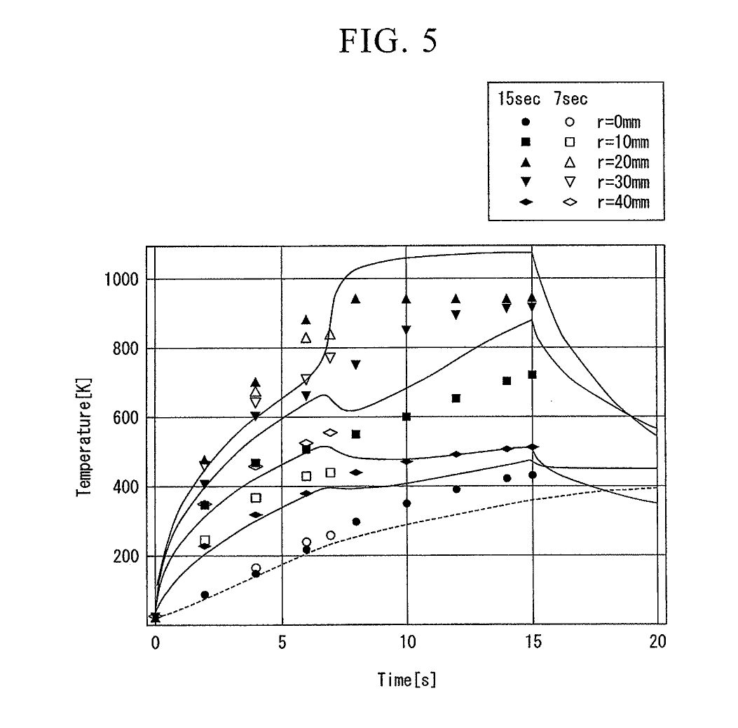

FIG. 5 is a diagram illustrating the measured temperatures and the results of analysis at respective temperature measurement points of the flat-plate steel. The solid lines and dashed line in FIG. 5 indicate the results of the analysis (i.e. calculated values).

According to the method of estimating the temperature distribution history of the related art, for example, the electromagnetic field that is generated from the high-frequency induction coil C and the induction current or the temperature distribution history that is generated in the flat-plate steel A are obtained by the coupling analysis for electromagnetic field and heat conduction using a general-purpose finite element method (FEM) code such as ANSYS (registered trademark).

In this case, an axial-symmetric two-dimensional model of the flat-plate steel A and the high-frequency induction coil C which are used in the general FEM code is prepared. The axial-symmetric two-dimensional model may be symmetric with respect to the Y-axis.

In the analysis of the electromagnetic field, it is necessary to also perform modeling of an air layer up to the infinite distance. Between the flat-plate steel A and the high-frequency induction coil C, an air layer that is the same as the air layer in the experiment device is arranged.

Further, as the second step, the history of the induction current distribution in the flat-plate steel A is calculated.

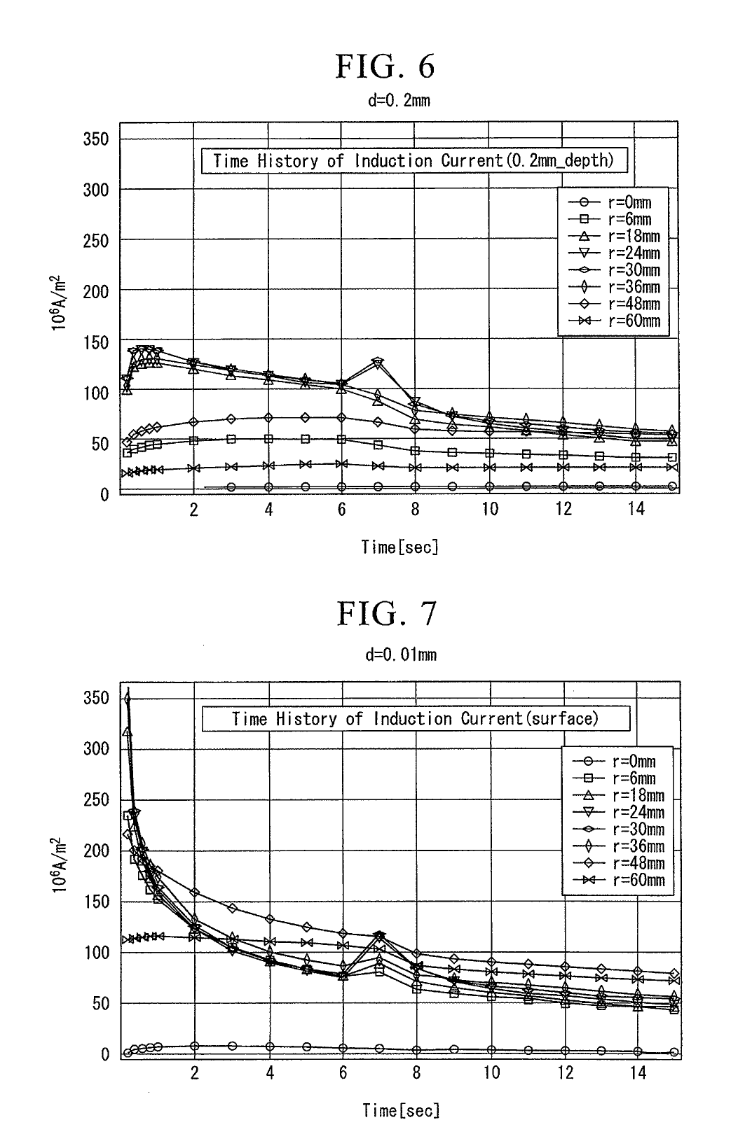

FIGS. 6 and 7 show the results of analysis of the induction current in the flat-plate steel A. FIG. 6 is a diagram illustrating the results of analysis of the induction current in the depth (or surface) of 0.2 mm, and FIG. 7 is a diagram illustrating the results of analysis of the induction current in the surface layer (with a depth of 0.01 mm).

At a depth (or surface) of 0.2 mm in a plate thickness direction (i.e. Z direction) from the surface layer that resides outside of the heat generation layer, the change in the induction current I with time is small (see FIG. 6). On the other hand, on the surface layer that is in the heat generation layer, it can be seen that the induction current is abruptly reduced as the temperature increases (see FIG. 7).

From the results as described above, it is clear that the induction current I can be approximated as the function of the position (r, z) of the flat-plate steel A and the temperature T.

As described above, it is considered that the induction current I can be approximated as the function of the position (r, z) of the flat-plate steel A and the temperature T. Its function equation is approximated as the following Equation (1).

I(r, z, T)=Io(r, z)w(T) (1)

In this case, Io(r, z) denotes the distribution of the induction current I at an initial temperature To (i.e. initial induction current distribution), and w(T) denotes the temperature dependent correction factor of the initial induction current distribution Io(r, z).

Accordingly, as the third step, after the approximation of the induction current I by Equation (1), the initial induction current distribution Io(r, z) and the temperature dependent correction factor w(T) in Equation (1) are identified based on the temperature distribution history obtained in the first step and the induction current distribution I(r, z, T) obtained in the second step.

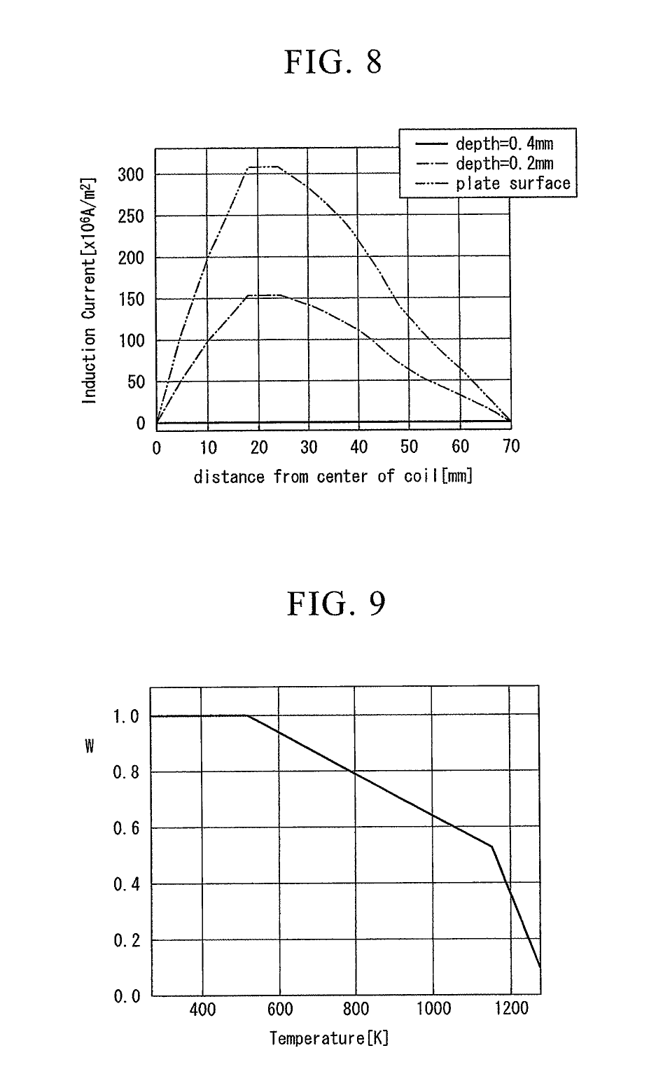

Accordingly, as shown in FIGS. 8 and 9, the initial induction current distribution Io(r, z) and the temperature dependent correction factor w(T) are identified.

FIG. 8 is a diagram illustrating the results of identification of the initial induction current distribution, and FIG. 9 is a diagram illustrating the results of identification of the temperature dependent correction factor.

As described above, if the induction current I can be approximated by Equation (1), the internal heat generation W according to the induction current I is expressed as in the following Equation (2).

W=I(r, z, T)²R(T)=Io(r, z)²w(T)²R(T) (2)

In this case, R(T) denotes the temperature dependency of the electrical resistivity of the flat-plate steel A.

Also, if the internal heat generation W that is generated in the flat-plate steel A can be obtained solely from the position (r, z) and the temperature T, it is possible to obtain the calculation of the temperature distribution history (i.e. thermal cycle) that is generated in the flat-plate steel A only by the analysis of the heat conduction.

Accordingly, it is not necessary to perform the analysis of the electromagnetic field that requires a huge number of man-hours.

In the fourth step, the temperature distribution history (i.e. thermal cycle) that is generated in the flat-plate steel A is obtained by the analysis of heat conduction by applying the initial induction current distribution Io(r, z) and the temperature dependent correction factor w(T), which are obtained in the third step, to Equation (2).

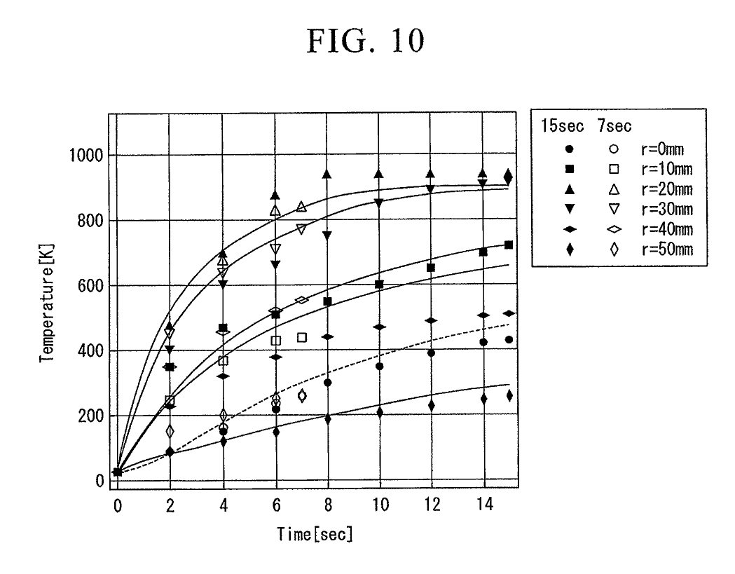

FIG. 10 is a diagram illustrating the comparisons of the calculated temperature histories obtained by applying the identified initial induction current distribution Io(r, z) and temperature dependent correction factor w(T) to Equation (2) with the measured temperature histories.

In this case, the solid lines and dashed line in the drawing indicate the results of analysis (i.e. calculated values). Also, FIG. 10 shows the actual measurement results of the temperature distribution history that are obtained by a confirmation test which is performed separately.

It can be seen that the results estimated by the analysis favorably coincide with the actual measurement results obtained in the first step. From the results of comparison, it can be confirmed that the induction current distribution I is favorably approximated by Equation (1), and the initial induction current distribution Io(r, z) and the temperature dependent correction factor w(T) are identified at high precision.

Then, in the fifth step, the temperature distribution history (i.e. thermal cycle) that is generated when the flat-plate steel A is line-heated is obtained by the analysis of heat conduction.

According to the analysis results in FIGS. 6 and 7, in a low-temperature region that is away from the heat generation region, the transition change of the induction current just after the start of the heating converges to be within one second. In the line-heating test, the moving distance of the high-frequency induction coil C in the transition period is equal to or less than 16 mm, which is sufficiently smaller than the steel plate size.

Accordingly, the internal heat generation W that corresponds to the induction current I obtained by Equation (1) is obtained by Equation (2), and the temperature histories in the flat-plate steel A during induction line heating process can be calculated when we analyze heat transfer and heat conduction updating the distributions of Iₒ(r, z) and w(T) at every time step so that their distributions around the coil equal to those of the spot-heating case. Accordingly, the temperature distribution history (i.e. thermal cycle) that is generated when the flat-plate steel A is line-heated can be obtained.

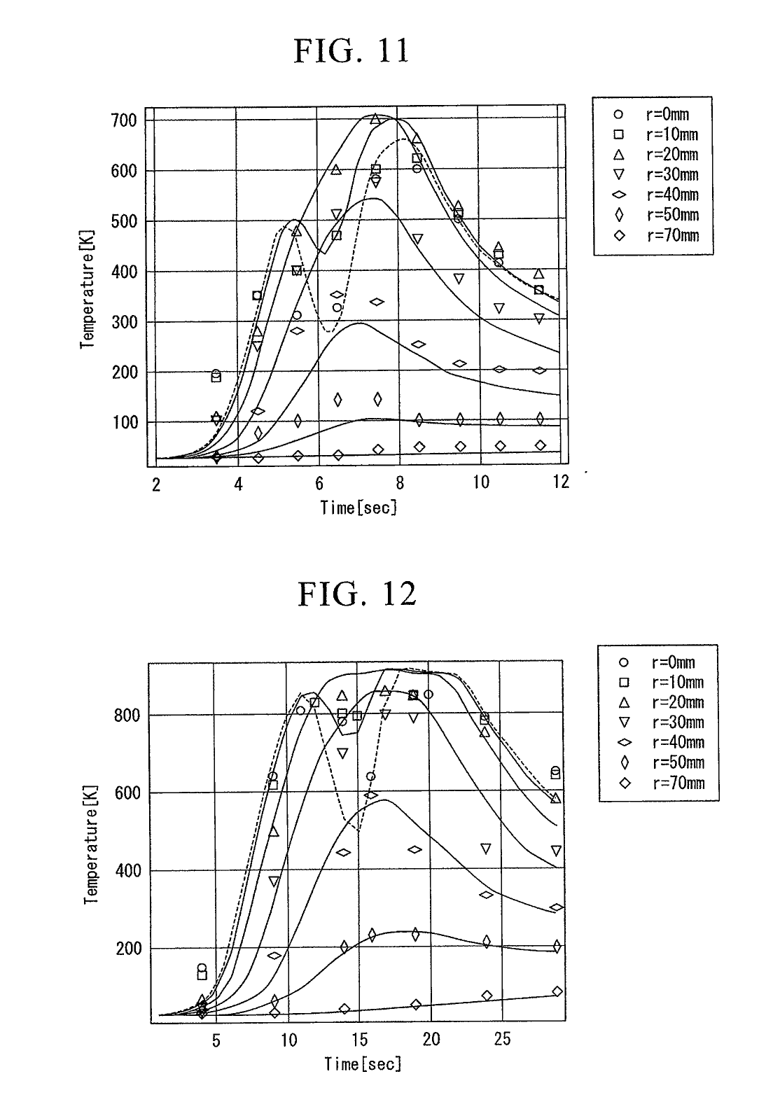

FIGS. 11 and 12 are diagrams illustrating the temperature distribution history (i.e. thermal cycle) when the flat-plate steel A is line-heated. FIG. 11 shows the temperature distribution history in the case where the moving speed of the high-frequency induction coil C is 1000 mm/min, and FIG. 12 shows the temperature distribution history in the case where the moving speed of the high-frequency induction coil C is 300 mm/min.

In this case, the solid lines and dashed line in the drawing indicate the results of analysis (i.e. calculated values). Also, FIGS. 11 and 12 show the actual measurement results of the temperature distribution history that are obtained by a confirmation test which is performed separately.

As illustrated in FIGS. 11 and 12, it can be seen that the results obtained by the method of estimating the temperature distribution history according to the embodiment of the present invention preferably coincide with the actual measurement results of the temperature distribution history.

As described above, by using the method of estimating the temperature distribution history according to the embodiment of the present invention, the temperature distribution history (i.e. thermal cycle) that is generated when the flat-plate steel A is line-heated can be analyzed (or estimated) with high precision.

Particularly, since only the internal heat generation W that is obtained by the heat-conduction analysis is used in the fifth step, i.e. in the step of analyzing the line heating, the temperature distribution history (i.e. thermal cycle) can be analyzed (or estimated) with high precision in a short amount of time without performing a cumbersome electromagnetic field analysis.

That is, by using the internal heat generation W that is obtained through the first step to the fourth step, the temperature distribution history (i.e. thermal cycle) when the flat-plate steel A is line-heated can be efficiently obtained at high precision without performing the electromagnetic field analysis in the step of analyzing the line heating (i.e. the fifth step) even if the moving speed of the high-frequency induction coil C is changed or the high-frequency induction coil C is not moved in a straight line.

In this case, the order of operations as described in the above-described embodiments of the present invention, the shapes of the respective constituent members or the combinations thereof are exemplary, and can be modified in various ways without departing from the scope of the invention.

### INDUSTRIAL APPLICABILITY

As described above, according to the present invention, the method of efficiently estimating the temperature distribution history with high precision in the case where the flat-plate steel is line-heated by high frequency induction can be provided.

1. A method of estimating a temperature distribution history, comprising:
a first step of measuring a history of temperature distribution that is generated when a test piece of sheet steel is spot-heated by high-frequency induction;
a second step of obtaining an induction current distribution, which is generated when the sheet steel is spot-heated by the high-frequency induction, by using finite element analysis;
a third step of expressing the induction current distribution by an approximation equation of the initial induction current distribution at an initial temperature and temperature dependent correction factors of the initial induction current, and identifying the initial induction current distribution and the temperature dependent correction factors based on the temperature distribution history obtained in the first step and the induction current distribution obtained in the second step;
a fourth step of obtaining internal heat generation from the initial induction current distribution and the temperature dependent correction factor obtained in the third step and a temperature dependency of electrical resistivity of the sheet steel; and
a fifth step of obtaining the temperature distribution history generated during the line heating by the finite element analysis by applying the internal heat generation that is obtained in the fourth step to the sheet steel while the internal heat generation is being moved.

2. The method according to claim 1, wherein in the fifth step, the internal heat generation is applied to the sheet steel as the internal heat generation moves in a straight line or in a curve with respect to a main surface of the sheet steel.

3. The method according to claim 1, wherein in the fifth step, the internal heat generation is applied to the sheet steel as the internal heat generation moves at constant speed or at varying speed with respect to the sheet steel.

4. The method according to claim 1, wherein in the first step, the sheet steel is spot-heated by a high-frequency induction coil.

5. The method according to claim 3, wherein in the first step, the sheet steel is spot-heated by a high-frequency induction coil.

6. The method according to claim 2, wherein in the fifth step, the internal heat generation is applied to the sheet steel as the internal heat generation moves at constant speed or at varying speed with respect to the sheet steel.

7. The method according to claim 2, wherein in the first step, the sheet steel is spot-heated by a high-frequency induction coil.

8. The method according to claim 6, wherein in the first step, the sheet steel is spot-heated by a high-frequency induction coil.
